(19) United States
(12) Patent Application Publication
(10) Pub. No.: US 2010/0096198 A1
(43) Pub. Date: Apr. 22, 2010

(54) Electrical Vehicle Battery Set Circuitry

(76) Inventor: Gordon Liao, Yung Kang City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/254,053

(22) Filed: Oct. 20, 2008

(51) Int. Cl. B60K 1/04

(52) U.S. Cl. 180/65.8

(57) ABSTRACT

An electrical vehicle battery set circuitry is disclosed, comprising: multiple battery holders, connected in parallel inside the electrical vehicle, each has a positive and a negative power cords, where the positive power cords each connects with a diode, and all are combined into a bigger positive power cord, while the negative power cords are directly combined into a bigger negative power cord, for the conduction of the electric current to the control unit of the electrical vehicle; multiple battery sets, laid fixedly on the battery holders; by exploiting the rectifying property of the diode, the electrical vehicle is capable of being added or replaced various similar or dissimilar types of batteries, and able to settle the charging between batteries, which would accomplish the handiness in use and lengthen the life of battery set.

### BACKGROUND OF THE INVENTION

1. Field of the Invention

The present invention relates to electrical vehicle battery set circuitry and more particularly to one featuring replacing or adding batteries at will, and freeing of charging between batteries, which actually boosts the handiness in use and the life of battery set.

2. Description of the Prior Art

The electric power system for the popular electrical vehicles is a battery set combined in series or in parallel of similar batteries, and the majority among them have only one battery. Since the battery capacity of the battery set delimits the working distance of the electrical vehicle, big battery capacity means longer working distance; however, it takes sizable volume and appends extra weight to the vehicle, which seems not economical for the short range uses; on the contrary, for the vehicle carrying small battery capacity, it for sure has insufficient working distance; in the case of two battery sets, the combination in parallel will bring about the drawback of charging each other, subject to the different voltages between the two, which substantially deteriorates the battery life, absolutely deserving an extensive improvement. The applicant of this invention realized the situation and instructed the inventor to push hardly ahead with the research and design, and eventually gave birth to the present invention.

### SUMMARY OF THE INVENTION

The objective of the present invention is to provide a electrical vehicle battery set circuitry that is capable of being replacing or adding batteries at will, and settling the problem of freeing of charging by each other, to boost the handiness in use and the life of battery set, which therefore improves the drawbacks of the prior art battery sets thoroughly.

To achieve the aforementioned objects, this invention comprises: a plurality of battery holders, connected in parallel inside the electrical vehicle, each has a positive and a negative power cords, where the positive power cords each connects with a diode, and all are combined into a bigger positive power cord, while the negative power cords are directly combined into a bigger negative power cord, for the conduction of the electric current to the control unit of the electrical vehicle; a plurality of battery sets, laid fixedly on the battery holders; by means of the rectifying property of the diode, the electrical vehicle is capable of being added or replaced various similar or dissimilar types of batteries, and able to settle the charging between batteries, which undoubtedly carries out the handiness in use and lengthens the life of battery set.

### BRIEF DESCRIPTION OF THE DRAWINGS

FIG. 1 is a three-dimensional diagram showing the present invention;

FIG. 2 is an exploded view of the present invention; and

FIG. 3 is a circuit diagram of the present invention.

### DETAILED DESCRIPTION OF THE INVENTION

The structural traits and the achievable functioning of the present invention are detailed described with reference to the following preferred exemplified embodiment and the accompanying drawings, which would assist the honorable Examiner in comprehending and recognizing the present invention.

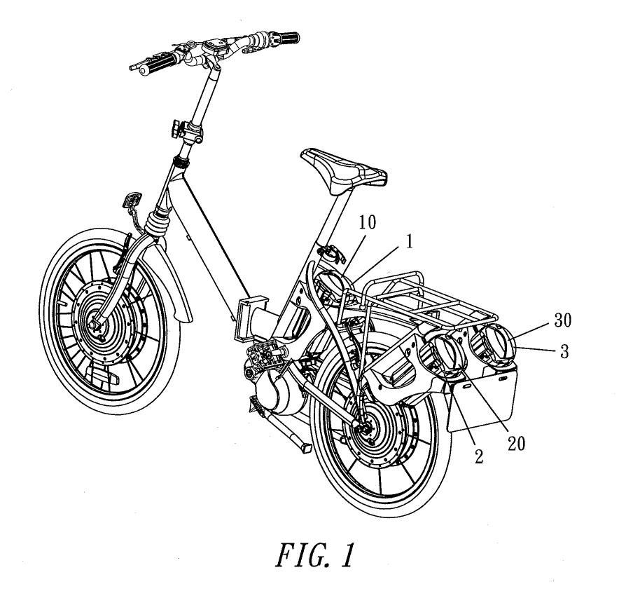

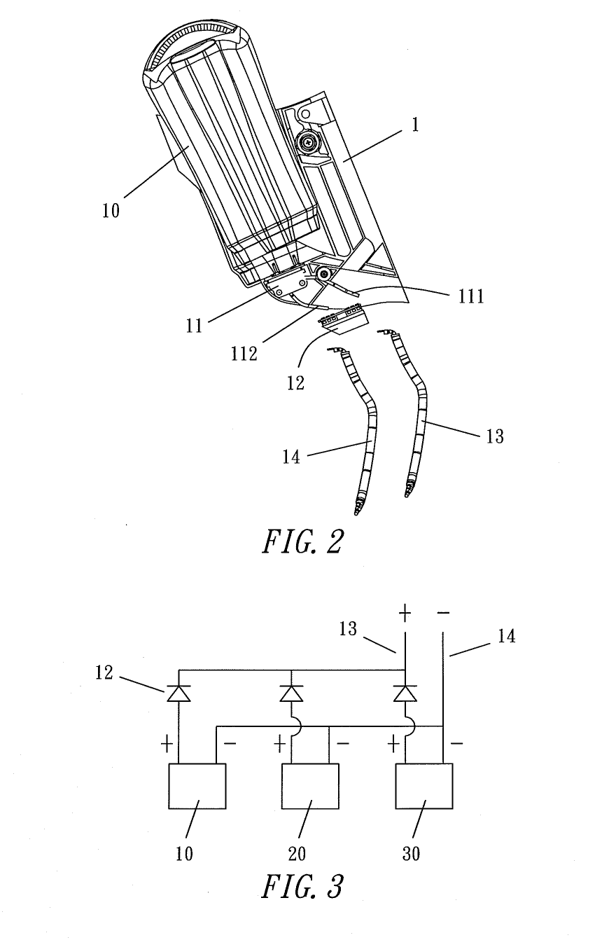

Referring to FIGS. 1-3, the present invention comprises: a plurality of battery holders 1, 2 and 3, connected in parallel at right places in the electrical vehicle (for instance, electrical bike). Plurality means quantity more than (equal to) two. The battery holders 1, 2 and 3 each is provided with a power jack 11 at its bottom, and the power jack 11 is connected by a positive power cord 111 and a negative power cord 112, where each positive power cord 111 joins a diode 12 first, and all the positive power cord 111 are then combined into a bigger positive power cord 13, which conducts electric current through to the control unit of the electrical vehicle, while the negative power cords 112 are directly combined into a bigger negative power cord 14, for making the power cords a closed loop with the control unit of the electrical vehicle; and a plurality of batteries 10, 20 and 30, laid fixedly on the battery holders 1, 2 and 3, the batteries each is connected to the power jack 11 at its one end, where any battery can be replaced at will; moreover, the user could add one, two or three more batteries subject to the distance of the intending journey.

According to the above structural combination, the battery holders 1, 2 and 3 are in parallel in the electrical vehicle, and the batteries 10, 20 and 30 are naturally connected in parallel, where the batteries 10, 20 and 30 each has its own power jack 11 for the electric power conduction, and each power jack 11 has its positive terminal connected by a diode 12; therefore, by exploiting the rectifying property of the diode 12, only the electric current flowed from the batteries 10, 20 and 30 through the diodes 12 and the connection in parallel for discharging is allowed; that is to say, the diodes 12 connected by the batteries 10, 20 and 30 allow the discharging only, not the charging of the batteries, so as to settle the problem of charging between batteries, and to enable different types of batteries included in the battery set.

For instance, there are two batteries 10 and 20, and the voltage of the battery 10 is lower that of the battery 20, the battery 20 could not have its electric current flow back to the battery 10, so that the battery 20 is not able to charge the battery 10. For three batteries 10, 20 and 30, similarly the higher voltage battery could not charge the lower voltage battery. Hence, among the three batteries, one is lithium (Li) battery, and the other two are lead-acid batteries. Due to the fact that the full-charge voltage of Li battery is higher than that of lead-acid battery, and under the circuitry of the present invention, the Li battery will not charge the lead-acid batteries.

Accordingly, the present invention exploits the rectifying property of the diode 12 for the one-way control of the electric current flow, which enables the adding or replacing similar or different types of batteries to and from the battery set of the electrical vehicle, unquestionably handy for the uses, and free of complicated circuitry, to ultimately settle the charging problem between batteries, and by all means to lengthen the battery life, which is definitely superior than the prior art battery sets.

To sum up, the disclosed concrete structure of the exemplified embodiment of the present invention is not only unknown to the prior art, but surely can accomplish the expected objective and function, which is construed as absolutely novel and creativeness and is compliant to the requirements of patent law, and a patent application for the invention is then filed.

What is claimed is:

1. An electrical vehicle battery set circuitry, comprising:
a plurality of battery holders, connected in parallel inside the electrical vehicle, each having a positive and a negative power cords, where the positive power cords each is connected with a diode, and all being combined into a bigger positive power cord, while the negative power cords are directly combined into a bigger negative power cord, for the conduction of the electric current to the control unit of the electrical vehicle;
a plurality of battery sets, laid fixedly on the battery holders;
by exploiting the rectifying property of the diode, the electrical vehicle being capable of being added or replaced various similar or dissimilar types of batteries, and able to settle the charging between batteries, which undoubtedly accomplish the handiness in use and lengthen the life of battery set.
